(19) United States
(12) Patent Application Publication
(10) Pub. No.: US 2007/0137054 A1
(43) Pub. Date: Jun. 21, 2007

(54) Compass

(76) Inventor: Jui-An Tsai, Yuan City (TW)

Correspondence Address: TROXELL LAW OFFICE PLLC, 5205 LEESBURG PIKE, SUITE 1404, FALLS CHURCH, VA, 22041, US

(21) Appl. No.: 11/304,733

(22) Filed: Dec. 16, 2005

(51) Int. Cl. G01C 17/00

(52) U.S. Cl. 33/355 R

(57) ABSTRACT

A compass including a decorative container and a bearing is disclosed. The decorative container is disposed on top of the bearing while a base for spire is arranged on surface of the container. A symmetrical C-shaped balancing stand has two brackets for accommodation of heavy objects on bottom of two sides thereof. A magnetized bar is transversely arranged on the symmetrical C-shaped balancing stand and a center point of the magnetized bar aligns a central shaft of the balancing stand. A projective spire is arranged on center shaft of the bottom of the balancing stand for being located on the base for spire so as to form a pivot point for rotation. Therefore, the balancing stand rotates freely above the decorative container and the magnetized bar thereof aligns with earth's magnetic field so as to drive the balancing stand to rotate and indicate directions.

### BACKGROUND OF THE INVENTION

The present invention relates to a compass, especially to a compass having a C-shaped balancing stand with heavy objects on two sides thereof. A magnetized bar arranged transversely and a spire facing downwards are disposed on a center shaft of the balancing stand and the spire is located on a base for spire so as to form a suspending pivot-point. Thus the compass not only indicates directions but also has decorative effect.

The compass available now is a small disc enclosed in a housing. A transparent window is on top surface for users to observe the direction while a shaft as well as a needle is arranged inside the compass. The friction between the needle and the shaft should be minimized so as to make the needle in a free and balanced status for finding earth's magnetic field and pointing in a northerly or southerly direction. However, conventional compasses only indicate directions with a small needle inside a disc. It has no decorative effect.

### SUMMARY OF THE INVENTION

Therefore it is a primary object of the present invention to provide a compass that includes a decorative container installed on a bearing. A base for spire supporting a C-shaped balancing stand is disposed on top surface of the container. The balancing stand has two symmetrical brackets for accommodation of heavy objects on bottom of two sides thereof. A magnetized bar and a pointer are transversely arranged on the balancing stand and a center point of the magnetized bar aligns a central shaft of the balancing stand. A projective spire is arranged on center shaft of the bottom of the balancing stand for being located on the base for spire so as to form a pivot point for rotation. Therefore, by the action of the heavy objects on two sides of the balancing stand as well as low friction of the pivot point that the spire locates on the base for spire, the balancing stand suspends and rotates over the decorative container and the magnetized bar moves freely to align itself accurately with earth's magnetic field and further drives the balancing stand as well as the pointer to indicate directions.

It is another object of the present invention to provide a compass whose pointer with various shapes such as arrowhead pointing needle is disposed outside for replacing a conventional magnetized needle and increasing ornamental effect.

It is another object of the present invention to provide a compass further having ornaments such as pen holders, pens or thermometers loaded on a central shaft of the balancing stand so as to increase decorative effect of the present invention.

### BRIEF DESCRIPTION OF THE DRAWINGS

FIG. 1 is a perspective view of an embodiment in accordance with the present invention;

FIG. 2 is an explosive view of the embodiment in FIG. 1;

FIG. 3 is a cross-sectional view of the embodiment in FIG. 1;

FIG. 4 is a schematic diagram of the embodiment in accordance with the present invention in usage;

FIG. 5 is another schematic diagram of the embodiment in accordance with the present invention in usage;

FIG. 6 is an explosive view of the embodiment in FIG. 5.

### DETAILED DESCRIPTION OF THE PREFERRED EMBODIMENT

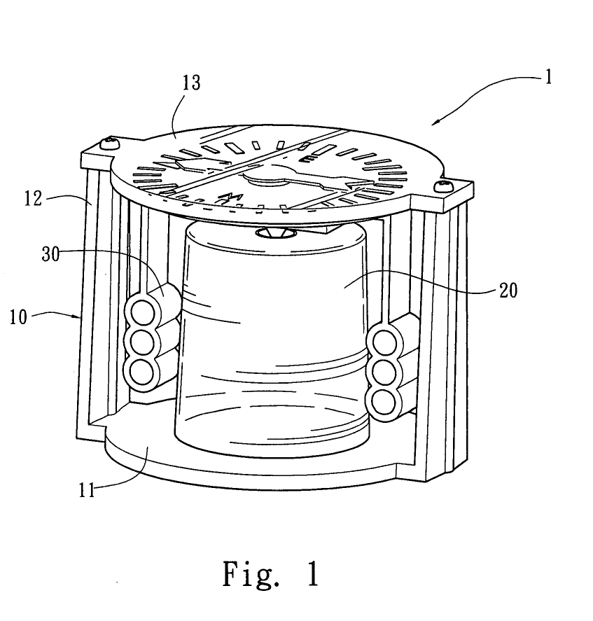

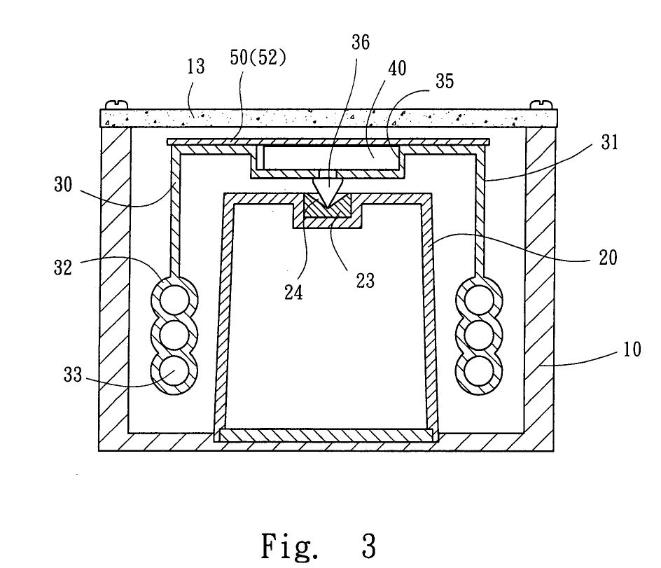

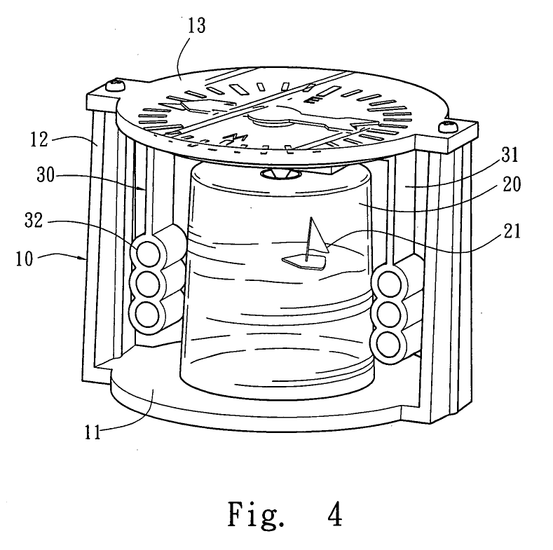

Refer from FIG. 1 to FIG. 3, a compass 1 in accordance with the present invention consists of a bearing 10, a decorative container 20, a balancing stand 30, a magnetized bar 40, and a pointer 50 such as a needle. There is no limitation on shape of the bearing 10 and it's better to see the inner space. A base 11 and an upper cover 13 are made from transparent plastic through injection molding. The upper cover 13 is assembled on the base 11 by two racks 12 on the base 1 1 to form a structure. As shown in FIG. 1 & FIG. 4, user can see through the inner space by the transparent upper cover 13. A slot 14 for locating and accommodation of the decorative container 20 is mounted on the base 11. The decorative container 20 is a housing arranged horizontally with various shapes and is better transparent so as to display various ornaments 21 therein, as shown in FIG. 4. Another slot 22 is disposed on center of top surface of the decorative container 20 for mounting a base for spire 23. The base for spire 23 is preferably made from abrasion resistant metal and forms a reverse conical surface for supporting 24. The balancing stand 30 is a C-shaped stand with right-and-left symmetry, having two sides 31 extend downward a certain length, and a plurality of brackets 32 symmetrically on bottom of the two sides 31 for accommodation of heavy objects 33 such as meal bobs symmetrically. Thus the balancing stand 30 maintains a kind of balanced status. The magnetized bar 40 is disposed transversely on the balancing stand 30. For example, a groove 35 is mounted on a middle part 34 of the balancing stand 30 so as to accommodate the magnetized bar 40 and a center point 41 (interface of N, S poles) of the magnetized bar 40 aligns a center shaft 37 of the balancing stand 30. Moreover, a spire 36 that locates on the center shaft 37 of the balancing stand 30 is set on bottom surface of the groove 35 of the balancing stand 30. The top end of the spire 36 is located on center of the reverse conical surface for supporting 24 on the base for spire 23 so as to be a pivot point for the balancing stand 30.

In usage, by the action of the heavy objects 33 on bottom of two sides 31 of the balancing stand 30 as well as low friction of the pivot point that the spire 36 locates on the base for spire 23, the balancing stand 30 suspends and rotates over the decorative container 20 and the magnetized bar 40 moves freely to align itself accurately with earth's magnetic field and further drives the balancing stand 30 rotating synchronously for indicating directions.

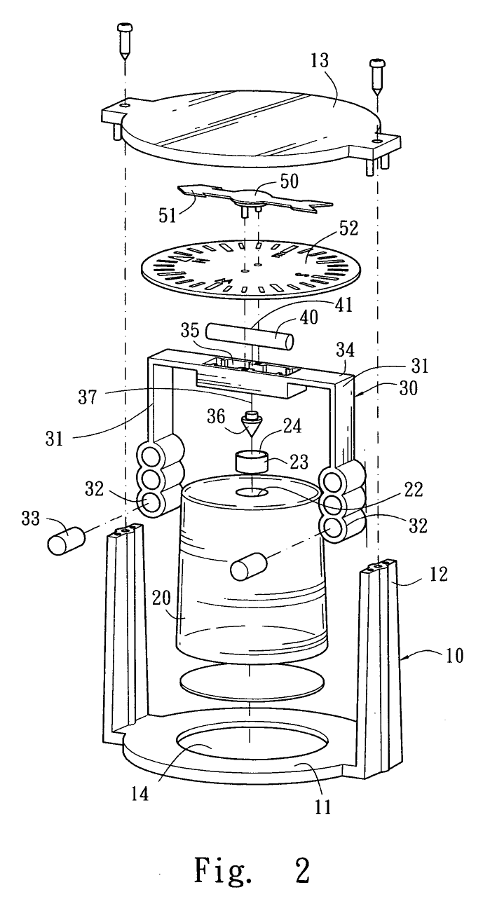

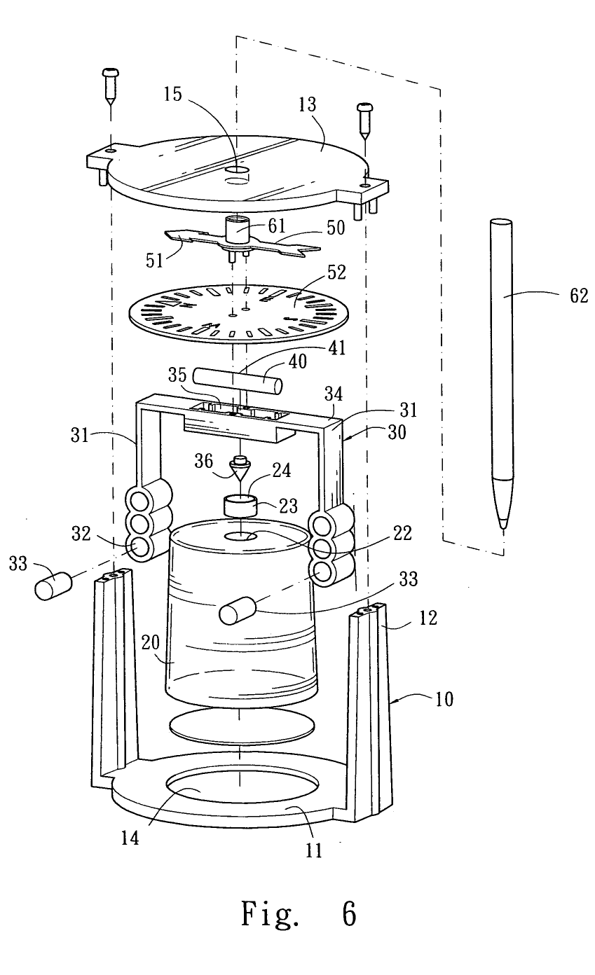

The pointer 50 is transversely arranged on the middle part 34 of the balancing stand 30 and is moving synchronously with the balancing stand 30. The pointer 50 is designed into various indicating signs according to users' needs, such as arrowhead needle shown in FIG. 2 & FIG. 6. The indicating sign 51 of the pointer 50 such as the arrowhead turns to the S pole of the magnetized bar 40 so that the pointer 50 moves synchronously with the magnetized bar 40 for pointing in a northerly direction. Because the volume of the pointer 50 is larger than conventional needle of the compass and the pointer 50 with various shapes is disposed outside the container 10, it is obvious to see the pointer 50. The pointer 50 not only replaces small magnetized needle inside the housing of traditional compass but also provides decorative effect of the compass 1 in accordance with the present invention.

Moreover, the pointer 50 can be used in combination with a scale 52 that is under and moving along with the pointer 50. The northerly direction of the scale 52 faces the indicating sign 51 of the pointer 50 so that users can see the pointer 50 as well as the scale 52 through the transparent upper cover 13, a shown in FIG. 1 & FIG. 4. By the scale 52, users further learn the cardinal points-north, south, east and west and the detailed angle of each direction.

Furthermore, the transparent decorative container 20 can be open or enclosed and the ornaments 21 therein can be solid or liquid. The liquid is single-type or double-type that including water, oil and floats on surface of the liquid, as shown in FIG. 4. It is also feasible to arrange a plurality of LED (light-emitting diode) on bottom of the decorative container 20 so as to have lighting effect.

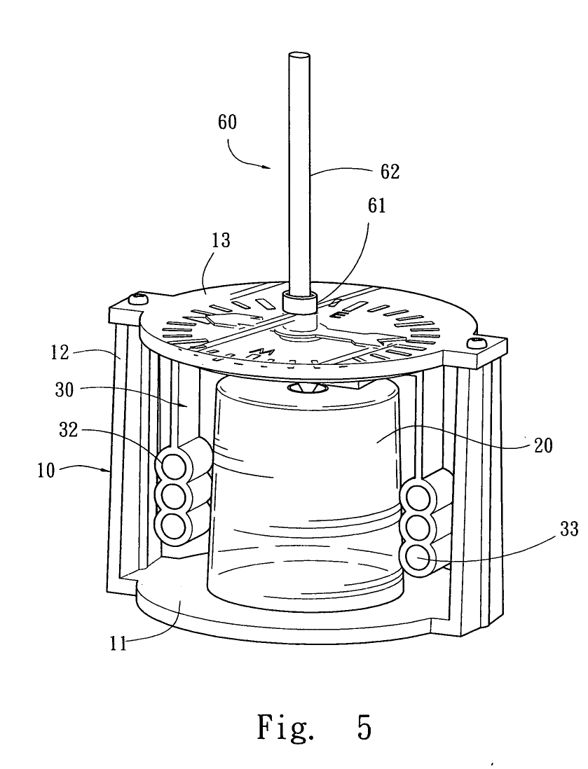

In addition, refer to FIG. 5 & FIG. 6, an ornament 60 is further loaded on the balancing stand 30. The ornament 60 can be a pen 62, a thermometer or other objects (not shown in figure). The ornament 60 such as pen holder 61 is directly disposed on a center shaft of the pointer 50, inserting through a central hole 15 of the upper cover 13 and exposing outside the upper cover 13 so as to increase the decorative effect of the present invention.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A compass comprising a bearing, a decorative container, a balancing stand, a magnetized bar, and a pointer, wherein:
the bearing having a base and an upper cover is a rack that is able to see through inner space;
the decorative container is a transparent housing arranged horizontally with ornaments therein; a slot mounted with a base for spire therein is disposed on center of top surface of the decorative container and the base for spire having a reverse conical surface for supporting;
the balancing stand is a C-shaped stand in right-and-left symmetry, having a plurality of brackets arranged symmetrically on bottom of the two sides for accommodation of heavy objects so that the balancing stand is in a balanced status; the magnetized bar is arranged on middle part of the balancing stand and a projective spire is arranged on bottom of the center shaft of middle part of the balancing stand while top end of the spire is located on center of the reverse conical surface for supporting on the base for spire so as to be a pivot point for the balancing stand; thus, the balancing stand suspends and rotates freely above the decorative container
the magnetized bar is disposed transversely on middle part of the balancing stand and a center point of the magnetized bar aligns a center shaft of the balancing stand; and
the pointer is transversely arranged on the middle part of the balancing stand and its indicating sign turns to the S pole of the magnetized bar so that the pointer moves synchronously with the magnetized bar;
thereby, the balancing stand suspends and rotates above the decorative container and the magnetized bar thereof aligns with earth's magnetic field so as to drive the balancing stand as well as the pointer to move synchronously for indicating directions.

2. The compass as claimed in claim 1, wherein the base for spire is preferably made from abrasion resistant metal.

3. The compass as claimed in claim 1, wherein the heavy objects are metal bobs.

4. The compass as claimed in claim 1, wherein a scale is under and moving along with the pointer while the northerly direction of the scale faces the indicating sign of the pointer.

5. The compass as claimed in claim 1, wherein the decorative container is open or enclosed while the enclosed container having liquid ornament therein.

6. compass as claimed in claim 5, wherein the liquid ornament is single-liquid or double-liquid.

7. The compass as claimed in claim 1, wherein the balancing stand is further disposed with ornament.

8. The compass as claimed in claim 7, wherein the ornament is a pen holder or a thermometer.

9. The compass as claimed in claim 7, wherein the ornament is disposed on a center shaft of the pointer, inserting through a central hole of the upper cover and exposing outside the upper cover.
